(19) United States
(12) Patent Application Publication
(10) Pub. No.: US 2024/0412534 A1
(43) Pub. Date: Dec. 12, 2024

(54) DETERMINING A ROAD PROFILE BASED ON IMAGE DATA AND POINT-CLOUD DATA

(71) Applicant: QUALCOMM Incorporated, San Diego, CA (US)

(72) Inventors: Senthil Kumar YOGAMANI, Headford (IE); Varun RAVI KUMAR, San Diego, CA (US); Deeksha DIXIT, San Diego, CA (US)

(21) Appl. No.: 18/330,203

(22) Filed: Jun. 6, 2023

(51) Int. Cl. G06V 20/56; B60W 60/00; G06V 10/82; G06V 20/58

(52) U.S. Cl. CPC G06V 20/588; B60W 60/001; G06V 10/82; G06V 20/58; B60W 2420/403; B60W 2552/20; B60W 2552/35

(57) ABSTRACT

Systems and techniques are described herein for determining road profiles. For instance, a method for determining a road profiles is provided. The method may include extracting image features from one or more images of an environment, wherein the environment includes a road; generating a segmentation mask based on the image features; determining a subset of the image features based on the segmentation mask; generating image-based three-dimensional features based on the subset of the image features; obtaining point-cloud-based three-dimensional features derived from a point cloud representative of the environment; combining the image-based three-dimensional features and the point-cloud-based three-dimensional features to generate combined three-dimensional features; and generating a road profile based on the combined three-dimensional features.

### TECHNICAL FIELD

The present disclosure generally relates to determining environment data based on input data. For example, aspects of the present disclosure include systems and techniques for determining a road profile and/or a perturbation map based on image data, point-cloud data, and/or map data.

### BACKGROUND

A driving system (e.g., an autonomous or semi-autonomous driving system) of a vehicle may determine information about roads on which the vehicle is driving. The driving system may use images captured at cameras on the vehicle to determine information about the roads on which the vehicle is driving. For example, the driving system may identify lanes based on captured images. Determining information about roads may allow the driving system to accurately navigate (e.g., autonomously navigate in an autonomous driving system or assist a driver in navigating in a semi-autonomous driving system) the vehicle through the environment by making intelligent motion-planning and trajectory-planning decisions.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for determining road profiles. According to at least one example, an apparatus for determining road profiles is provided. The apparatus includes at least one memory and at least one processor coupled to the at least one memory. The at least one processor is configured to: extract image features from one or more images of an environment, wherein the environment includes a road; generate a segmentation mask based on the image features; determine a subset of the image features based on the segmentation mask; generate image-based three-dimensional features based on the subset of the image features; obtain point-cloud-based three-dimensional features derived from a point cloud representative of the environment; combine the image-based three-dimensional features and the point-cloud-based three-dimensional features to generate combined three-dimensional features; and generate a road profile based on the combined three-dimensional features.

In another example, a method for determining road profiles is provided. The method includes: extracting image features from one or more images of an environment, wherein the environment includes a road; generating a segmentation mask based on the image features; determining a subset of the image features based on the segmentation mask; generating image-based three-dimensional features based on the subset of the image features; obtaining point-cloud-based three-dimensional features derived from a point cloud representative of the environment; combining the image-based three-dimensional features and the point-cloud-based three-dimensional features to generate combined three-dimensional features; and generating a road profile based on the combined three-dimensional features.

In another example, a non-transitory computer-readable medium is provided that has stored thereon instructions that, when executed by at least one processor, cause the at least one processor to: extract image features from one or more images of an environment, wherein the environment includes a road; generate a segmentation mask based on the image features; determine a subset of the image features based on the segmentation mask; generate image-based three-dimensional features based on the subset of the image features; obtain point-cloud-based three-dimensional features derived from a point cloud representative of the environment; combine the image-based three-dimensional features and the point-cloud-based three-dimensional features to generate combined three-dimensional features; and generate a road profile based on the combined three-dimensional features.

As another example, an apparatus is provided. The apparatus includes: means for extracting image features from one or more images of an environment, wherein the environment includes a road; means for generating a segmentation mask based on the image features; means for determining a subset of the image features based on the segmentation mask; means for generating image-based three-dimensional features based on the subset of the image features; means for obtaining point-cloud-based three-dimensional features derived from a point cloud representative of the environment; means for combining the image-based three-dimensional features and the point-cloud-based three-dimensional features to generate combined three-dimensional features; and means for generating a road profile based on the combined three-dimensional features.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system that may determine a road profile and/or a perturbation map based on image data, point-cloud data, and/or map data, according to various aspects of the present disclosure;

FIG. 2 is a block diagram illustrating an example system that may determine a road profile and/or a perturbation map based on images, point clouds, and/or a point map, according to various aspects of the present disclosure;

FIG. 3 is a flow diagram illustrating an example process for determining a road profile based on image data and point-cloud data, in accordance with aspects of the present disclosure;

FIG. 4 illustrates an example of a deep learning neural network that can be used to implement a perception module and/or one or more validation modules, according to some aspects of the disclosed technology;

FIG. 5 is an illustrative example of a convolutional neural network (CNN), according to various aspects of the present disclosure; and

FIG. 6 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

In the field of autonomous driving by driving systems (e.g., autonomous driving systems of autonomous vehicles and/or semi-autonomous driving systems of semi-autonomous vehicles) determining information about roads may be important. This can become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving (for a semi-autonomous driving system), where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain at the in the driver's seat behind the steering wheel. Vehicles operating at autonomy level 4 can communicate and inform other vehicles about upcoming maneuvers (e.g., a vehicle is changing lanes, making a turn, stopping, etc.). Vehicles operating at autonomy level 5 are fully autonomous, self-driving vehicles that operate autonomously in all conditions. A human operator is not needed for the vehicle to take any action. In the present disclosure, the term “autonomous driving system” may refer to any level of autonomous or semi-autonomous driving system, including advanced driver assistance systems (ADAS). Additionally, in the present disclosure, the term “autonomous vehicle” may refer to a vehicle with any level of autonomy, including semi-autonomous autonomous vehicles.

Autonomous driving systems have various ways of gathering data about roads. Autonomous vehicles typically include cameras that may capture images. Such autonomous driving systems may use various techniques to determine locations of lanes. For example, a trained machine-learning model (e.g., 3D-LaneNet) may generate three-dimensional representations of lanes based on images. Such three-dimensional representations may not represent lanes and road well, especially when the road is uneven (e.g., when the road traverses hills).

Systems, apparatuses, methods (also referred to as processes), and computer-readable media (collectively referred to herein as “systems and techniques”) are described herein for determining a road profile based on image data and point-cloud data (and in some cases map data). The systems and techniques described herein may obtain image-based three-dimensional features and point-cloud-based three-dimensional features. The image-based three-dimensional features may be derived from one more images of an environment including a road. For example, the image-based three-dimensional features may be extracted from one or more images using a machine-learning encoder. The point-cloud-based three-dimensional features may be derived from a point cloud representative of the environment. For example, the point-cloud-based three-dimensional features may be extracted from one or more point clouds (e.g., light detection and ranging (LIDAR) point clouds or other types of three-dimensional point clouds) using a machine-learning encoder.

In some cases, the systems and techniques may further obtain map-based three-dimensional features. For example, the map-based three-dimensional features may be extracted from a point map using a machine-learning encoder. A point map (e.g., a high-definition (HD) map) may include three-dimensional data (e.g., elevation data) regarding a three-dimensional space, such as a road on which a vehicle is navigating. For instance, the point map can include a plurality of map points corresponding to one or more reference locations in the three-dimensional space. In some cases, the point map can include dimensional information for objects in the three-dimensional space and other semantic information associated with the three-dimensional space. For instance, the information from the point map can include elevation or height information (e.g., road elevation/height), normal information (e.g., road normal), and/or other semantic information related to a portion (e.g., the road) of the three-dimensional space in which the vehicle is navigating. One illustrative example of a point map is an HD map. A point map (e.g., an HD map) may be three-dimensional (e.g., including elevation information). A point map (e.g., an HD map) may included a high level of detail (e.g., including centimeter level details).

In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

The systems and techniques may combine the image-based three-dimensional features, the point-cloud-based three-dimensional features, and/or the map-based three-dimensional features to generate combined three-dimensional features. In one illustrative example, the systems and techniques may use a volumetric voxel-attention transformer to combine the image-based three-dimensional features, the point-cloud-based three-dimensional features, and/or the map-based three-dimensional to generate the combined three-dimensional features. The systems and techniques may generate a road profile and/or a perturbation map based on the combined three-dimensional features. In one illustrative example, the systems and techniques may use a machine-learning decoder to decode the combined three-dimensional features to generate the road profile and/or the perturbation map.

A driving system may use the road profile and/or perturbation map to accurately navigate (e.g., autonomously navigate in an autonomous driving system or assist a driver in navigating in a semi-autonomous driving system) a vehicle through an environment by making intelligent motion-planning and/or trajectory-planning decisions. For example, the driving system may track lanes and/or vehicles using the road profile (e.g., determining lane boundaries and/or positions of vehicles according to the three-dimensional road profile). As another example, the driving system may control the vehicle according to the three-dimensional road profile (e.g. according to hills which the road traverses). As another example, the driving system may avoid potholes or bumps using the perturbation map.

Additionally, or alternatively, the systems and techniques may determine a location of one or more vehicles relative to the road based on the road profile. For example, a tracking vehicle may determine its own location relative to the road based on the road profile. Further the tracking vehicle may determine the locations of one or more target vehicles relative to the road based on the road profile. Additionally, or alternatively, the systems and techniques may transmit the road profile (and/or the perturbation map) to a server for generating or updating a point map of the road. For example, the server may generate or update a point map of the road based on the road profile and/or perturbation map transmitted by the systems and techniques. Additionally, or alternatively, the systems and techniques may determine to detect objects in the environment based on the road profile. For example, the systems and techniques may constrain object detection to objects that are on (or close to) the road as defined by the road profile.

Various aspects of the application will be described with respect to the figures below.

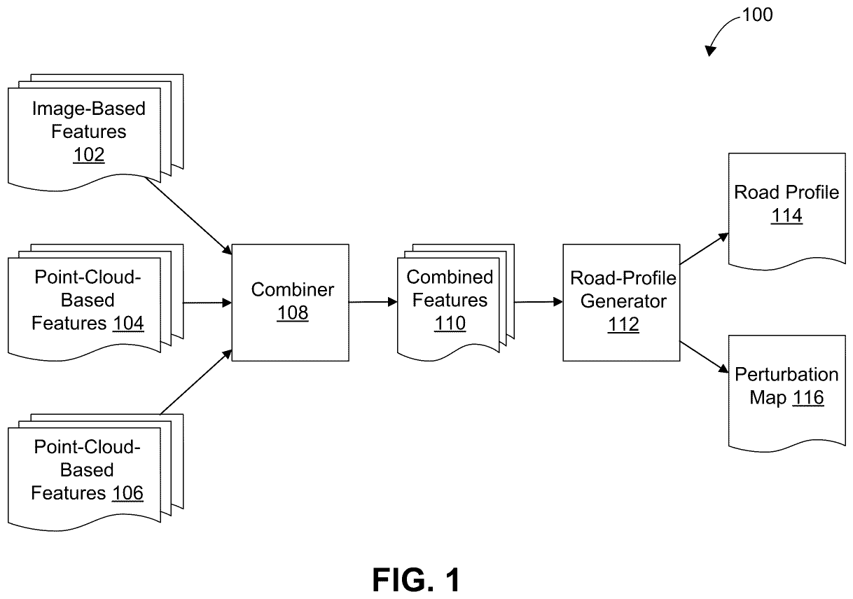

FIG. 1 is a block diagram illustrating an example system 100 that may determine a road profile 114 and/or a perturbation map 116 based on image data, point-cloud data, and/or map data, according to various aspects of the present disclosure. System 100 may be implemented in an autonomous driving system.

Image-based features 102 may be, or may include, features derived from one or more images. For example, an autonomous vehicle may include one or more cameras positioned on different portions of the autonomous vehicle to capture images of an environment surrounding the autonomous vehicle from different perspectives (e.g., one or more cameras on the front of the vehicle, on the sides of the vehicle, and the rear of the vehicle). The images may include a road (and/or other drivable surface) on which the autonomous vehicle is driving or will drive. An image encoder (e.g., an image convolutional neural network (CNN)) may extract features from the images. The features may be unprojected to generate the image-based features 102, which may be three-dimensional (e.g., the features may be unprojected into a three-dimensional voxel space).

Point-cloud-based features 104 may be, or may include, features derived from one or more point clouds. For example, an autonomous vehicle may include a point-cloud data-capture system (e.g., a light detection and ranging (LIDAR) system, a radio detection and ranging (RADAR) system, any combination thereof, and/or other point-cloud data-capture system). The point-cloud data-capture system may capture three-dimensional data, referred to as point clouds, representative of the environment of the autonomous vehicle. A point-cloud encoder (e.g., a CNN) may extract point-cloud-based features 104 from the point clouds. Point-cloud-based features 104 may be three-dimensional (e.g., voxels). For example, the point-cloud encoder (e.g., the CNN) may be a voxel-based encoder (e.g., a voxel-based CNN encoder) and point-cloud-based features 104 may be, or may include, features with respective positions in a three-dimensional space (e.g., a three-dimensional voxel space).

Map-based features 106 may be, or may include, features derived from a point map (e.g., a high-definition (HD) map) of the environment. For example, system 100 may have access to a point map of the environment. The point map may include three-dimensional data regarding roads (e.g., elevation data). A map encoder (e.g., a CNN) may extract map-based features 106 from the point map. Map-based features 106, based on a three-dimensional point map, may be three-dimensional.

Combiner 108 may combine image-based features 102, point-cloud-based features 104, and/or map-based features 106 to generate combined features 110. Combiner 108 may be, or may include, a machine-learning transformer. In some cases, combiner 108 may be, or may include, a three-dimensional self-attention transformer (e.g., a volumetric voxel-attention transformer). Combiner 108 may obtain image-based queries and point-cloud-based queries. Combiner 108 may use the image-based queries and the point-cloud-based queries to query image-based features 102, point-cloud-based features 104, and/or map-based features 106 to generate combined features 110 For example, combiner 108 may query a voxel space of image-based features 102, point-cloud-based features 104, and/or map-based features 106 according to the image-based query and/or the point-cloud-based query.

Road-profile generator 112 may receive combined features 110 and generate road profile 114 and/or perturbation map 116 based on combined features 110. Road-profile generator 112 may be, or may include, a trained machine-learning decoder (e.g., a CNN). Road-profile generator 112 may decode combined features 110 to generate road profile 114 and/or perturbation map 116.

In some cases, road-profile generator 112 may additionally receive an uncertainty map (e.g., describing probabilities of categorizations of image-based features 102). In such cases, road-profile generator 112 may further generate road profile 114 and/or perturbation map 116 based on the uncertainty map. For example, road-profile generator 112 may determine locations of potholes and/or speed bumps based on the uncertainty map because the uncertainty map may capture abrupt changes in the road profile generated by segmentation predictions. The uncertainty map may be used as prior features to the road profile decoder. In some cases, road-profile generator 112 may receive a road-elevation prior based on map-based features 106 obtained from the encoder that encoded map-based features 106.

Road profile 114 may be, or may include, a polynomial representation of the road. Road profile 114 may include coefficients of the polynomial. The polynomial may be a three-dimensional polynomial (e.g., including x, y, and z). The polynomial may be of any suitable order (e.g., fifth order, sixth order, seventh, order etc.). The polynomial may fit the road, in other words, the polynomial may be a mathematical description of the surface of the road.

Perturbation map 116 may be, or may include, a map of deviations from the road profile 114. For example, perturbation map 116 may be a two-dimensional map which may be mapped onto road profile 114. Road profile 114, may describe small or local deviations in the surface of the road from perturbation map 116. For example, perturbation map 116 may represent potholes or bumps in the road.

Road profile 114 may represent a globally smooth polynomial surface. Perturbation map 116 may represent subtle variations in the surface (e.g., to account for speed bumps and/or potholes). In one illustrative example, a pothole with a depth of 10 centimeters, detected from 200 meters away, may be determined to be noise by other detection systems (e.g., techniques relying on depth maps and/or occupancy grids). However, road profile 114 and perturbation map 116 together may model such potholes accurately. For example, it may be easier to regress a smooth polynomial surface which is globally consistent using the road profile 114 and perturbation map 116 together. A driving system may use road profile 114 and/or perturbation map 116 to accurately navigate a vehicle through an environment by making motion-planning and trajectory-planning decisions.

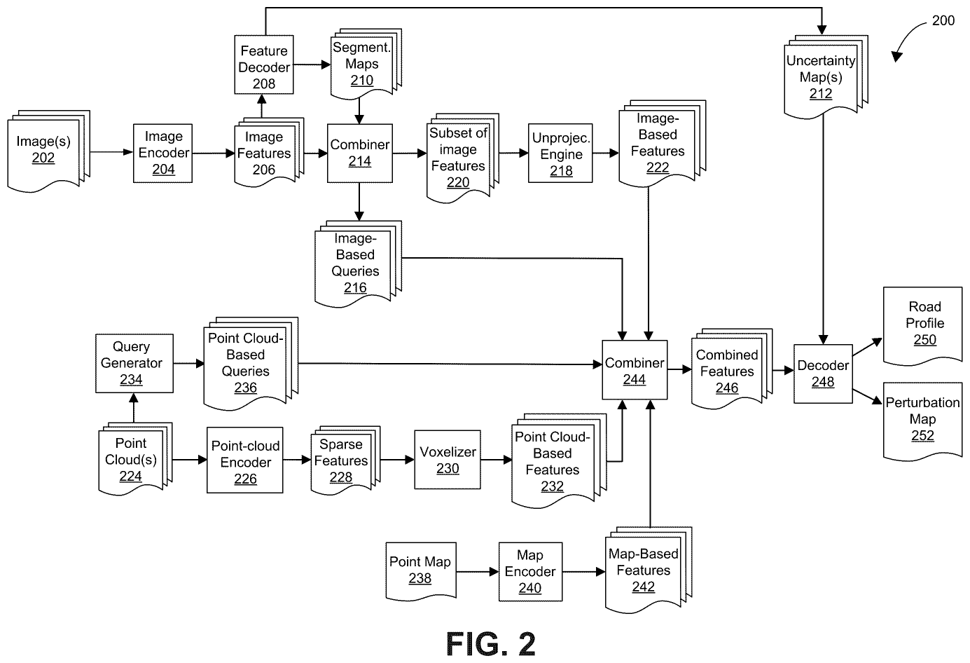

FIG. 2 is a block diagram illustrating an example system 200 that may determine a road profile 250 and/or a perturbation map 252 based on images 202, point clouds 224, and/or a point map 238, according to various aspects of the present disclosure. System 200 may be implemented in an autonomous driving system. System 200 may be an example implementation of system 100 of FIG. 1. System 200 may include additional details not included in system 100.

System 200 may receive images 202. Images 202 may be captured from one or more cameras positioned on an autonomous vehicle. Images 202 may include images captured by cameras facing in various directions. For example, images 202 may include images from cameras facing forward from autonomous vehicle, cameras facing left and right from the autonomous vehicle (e.g., mounted on a side-view mirror of the autonomous vehicle), and a camera facing behind the autonomous vehicle. Images 202 may represent an environment of autonomous vehicle. The environment may include a road or drivable surface on which the autonomous vehicle is driving or may drive.

System 200 may include an image encoder 204 which may extract image features 206 from images 202. Image encoder 204 may be, or may include, a machine-learning encoder, such as a convolutional neural network (CNN). Image encoder 204 may be, or may include, an image encoder. Image features 206 may be, or may include, feature maps based on images 202 and based on image encoder 204. Image features 206 may be of any size (e.g., based on a size of images 202 and a size of kernels of image encoder 204). Image features 206, based on two-dimensional images 202, may be two-dimensional.

System 200 may include a feature decoder 208 (also referred to as decoder 208) which may receive image features 206 and generate segmentation maps 210 based on image features 206. Decoder 208 may be, or may include a machine-learning decoder, such as a CNN decoder. Decoder 208 may be, or may include, semantic segmentation network and/or an instance segmentation network. Decoder 208 may generate segmentation maps 210 which may segment image features 206 into semantically labeled segments. For example, segmentation maps 210 may segment image features 206 into segments representing cars, buildings, roads and/or lanes. In some cases, decoder 208 may further generate uncertainty maps 212. Uncertainty maps 212 may include indications of certainties (or uncertainties) related to segmentation maps 210. For example, uncertainty maps 212 may include indications regarding portions of image features 206 that are segmented by segmentation maps 210 with a low degree of certainty. Uncertainty maps 212 may capture abrupt changes in the road profile generated by segmentation predictions. The abrupt changes may indicate local deviations in the surface of the road (e.g., potholes or speed bumps).

System 200 may include combiner 214 which may generate subset of image features 220 based on image features 206 and segmentation maps 210. Subset of image features 220 may be a subset of image features 206. Subset of image features 220 may be the subset of image features 206 identified by one or more segments defined by segmentation maps 210. For example, subset of image features 220 may be, or may include image features 206 that are related to the road and/or drivable surface. Combiner 214 may filter image features 206 to select subset of image features 220 that are related to the road and/or drivable surface and to exclude features related to cars, pedestrians, buildings, trees, etc.

Additionally, in some instances, combiner 214 may generate image-based queries 216 which may be, or may include, queries that may be used by a self-attention transformer to query a three-dimensional voxel space. Image-based queries 216 may be generated based on images that represent the voxel space. Image features 206 (that may be extracted from images 202) may be projected to a lower-dimensional space using a fully connected layer (e.g., of combiner 214) to create image-based queries 216. Image-based queries 216 may be based on lane and/or road locations of image features 206.

System 200 may include unprojection engine 218 which may unproject subset of image features 220 to generate image-based features 222. Image-based features 222 may be three-dimensional features. For example, unprojection engine 218 may unproject subset of image features 220 into a three-dimensional voxel space. Image-based features 222 may be an example of image-based features 102 of FIG. 1.

System 200 may receive point clouds 224. Point clouds 224 may be generated by a point-could capture system positioned on the autonomous vehicle. For example, the autonomous vehicle may include a LIDAR or RADAR system that may generate point clouds 224. Point clouds 224 may be, or may include, three-dimensional data representative of the environment (including the road) of the autonomous vehicle.

System 200 may include a point-cloud encoder 226 which may extract sparse features 228 from point clouds 224. Point-cloud encoder 226 may be, or may include, a machine-learning encoder, such as a CNN encoder (e.g., a voxel-based CNN, such as VoxelNet). Point-cloud encoder 226 may be, or may include, a voxel encoder. Sparse features 228, based on three-dimensional point clouds 224, may be, or may include, features with respective positions in a three-dimensional space (e.g., a three-dimensional voxel space).

System 200 may include a voxelizer 230 that may voxelize sparse features 228 into a three-dimensional voxel space to generate point-cloud-based features 232. In some instances, sparse features 228 may be selected to include only features related to the road. For example, in some instances, voxelizer 230 (or another element not illustrated in FIG. 2) may filter point-cloud-based features 232 using a filtering algorithm (e.g., random sample consensus (RANSAC) algorithm). Point-cloud-based features 232 may be an example of point-cloud-based features 104 of FIG. 1.

System 200 may include a query generator 234 which may generate point-cloud-based queries 236 based on point clouds 224. Point-cloud-based queries 236 may be, or may include, queries that may be used by a self-attention transformer to query a three-dimensional voxel space. Point-cloud-based queries 236 may be based on lane and/or road locations of point clouds 224.

In some cases, system 200 may receive or have a point map 238. Point map 238 may include a three-dimensional map of the environment. For example, point map 238 may be an HD map. Point map 238 may include information three-dimensional regarding lanes (e.g., elevation data).

System 200 may include a map encoder 240 which may process point map 238 to generate map-based features 242. Map encoder 240 may be, or may include, a machine-learning encoder, such as a CNN encoder. Map-based features 242, based on point map 238, may be three-dimensional. Map-based features 242 may be an example of map-based features 106 of FIG. 1.

System 200 may include a combiner 244 which may combine image-based features 222, point-cloud-based features 232, and/or map-based features 242 to generate combined features 246. Combiner 244 may be, or may include, a self-attention transformer. For example, combiner 244 may be, or may include a volumetric voxel-attention transformer. Combiner 244 may combine image-based features 222 (which may be three-dimensional) with point-cloud-based features 232 (which may be three-dimensional) and with map-based features 242 (which may be three-dimensional). Combiner 244 may generate combined features 246 which may represent a unified volumetric voxel space including features of image-based features 222, point-cloud-based features 232, and/or map-based features 242. Combiner 244 may be an example of combiner 108 of FIG. 1. Combiner 244 may combine image-based features 222, point-cloud-based features 232, and map-based features 242 based on image-based queries 216 and point-cloud-based queries 236.

Combiner 244 may use image-based queries 216 (which may be generated based on images that represent the voxel space) to attend over the features in the voxel space. Image-based queries 216 may be used as input to combiner 244 (which may be, or may include, a self-attention transformer) to attend over the voxel space. Additionally, combiner 244 may use point-cloud-based queries 236 to query a three-dimensional voxel space. For example, combiner 244 may extract features from the sparse features 228, project the features to a lower-dimensional space to create point-cloud-based queries 236, and use point-cloud-based queries 236 as input to a self-attention mechanism of combiner 244. Combiner 244 may compute attention scores between image-based queries 216 and point-cloud-based queries 236 and use the attention scores to weight the image-based queries 216 and point-cloud-based queries 236 before computing a final output.

For example, combiner 244 may query the voxel spaces of image-based features 222, point-cloud-based features 232, and/or map-based features 242 at locations based on image-based queries 216 and/or point-cloud-based queries 236 to obtain keys and values. The keys and values from the voxel space of image-based features 222, point-cloud-based features 232, and/or map-based features 242 may be used to generate combined features 246. Combined features 246 may be an example of combined features 110 of FIG. 1.

System 200 may include decoder 248 which may process combined features 246 to generate road profile 250 and/or perturbation map 252. Decoder 248 may be, or may include a machine-learning decoder, such as a CNN decoder. In some cases, decoder 248 may additionally be trained to generate road profile 250 and/or perturbation map 252 based on uncertainty maps 212. Decoder 248 may be an example of road-profile generator 112 of FIG. 1. Road profile 250 may be an example of road profile 114 of FIG. 1 and perturbation map 252 may be an example of perturbation map 116 of FIG. 1.

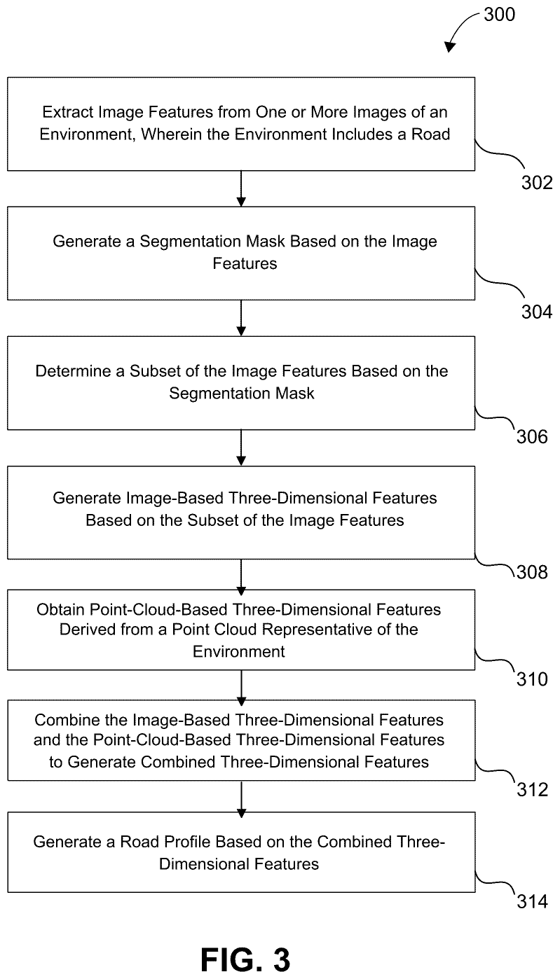

FIG. 3 is a flow diagram illustrating a process 300 for determining a road profile based on image data and point-cloud data, in accordance with aspects of the present disclosure. One or more operations of process 300 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 300. The one or more operations of process 300 may be implemented as software components that are executed and run on one or more processors.

At block 302, a computing device (or one or more components thereof) may extract image features from one or more images of an environment. The environment may include a road. For example, system 200 may obtain images 202. Image encoder 204 may extract image features 206 from images 202.

At block 304, the computing device (or one or more components thereof) may generate a segmentation mask based on the image features. For example, decoder 208 may generate segmentation maps 210 based image features 206.

At block 306, the computing device (or one or more components thereof) may determine a subset of the image features based on the segmentation mask. For example, combiner 214 may determine subset of image features 220 (e.g., a subset of image features 206) based on segmentation maps 210.

In some aspects, the wherein the determined subset of image features may be, or may include, features related to at least one of the road or lane boundaries of the road. For example, the subset may be determined to include features related to the road and/or lane boundaries of the road.

At block 308, the computing device (or one or more components thereof) may generate image-based three-dimensional features based on the subset of the image features. For example, unprojection engine 218 may generate image-based features 222 based on subset of image features 220.

In some aspects, to generate the image-based three-dimensional features, the computing device (or one or more components thereof) may unproject the subset of the image features. For example, unprojection engine 218 may unproject subset of image features 220 to generate image-based features 222.

At block 310, the computing device (or one or more components thereof) may obtain point-cloud-based three-dimensional features derived from a point cloud representative of the environment. For example, combiner 108 may obtain point-cloud-based features 104 of FIG. 1. As another example, combiner 244 may obtain point-cloud-based features 232 of FIG. 2.

Point-cloud-based features 232 may be based on point clouds 224 which may represent the environment.

In some aspects, the computing device (or one or more components thereof) may obtain the point cloud and generate the point-cloud-based three-dimensional features based on the point cloud. For example, system 200 may obtain point clouds 224 and point-cloud-based features 232 based on point clouds 224 (e.g., using point-cloud encoder 226 and voxelizer 230). In some aspects, the point cloud may be, or may include, a light detection and ranging (LIDAR) point cloud. For example, point clouds 224 may be, or may include, a LIDAR point cloud.

At block 312, the computing device (or one or more components thereof) may combine the image-based three-dimensional features and the point-cloud-based three-dimensional features to generate combined three-dimensional features. For example, combiner 108 may combine image-based features 102 and point-cloud-based features 104 to generate combined features 110. As another example, combiner 244 may combine image-based features 222 and point-cloud-based features 232 to generate combined features 246 of FIG. 2.

In some aspects, the computing device (or one or more components thereof) may generate image-based queries based on the subset of the image features. In some aspects, the computing device (or one or more components thereof) may generate point-cloud-based queries based on the point cloud. In some aspects, the computing device (or one or more components thereof) may obtain image-based queries based on the one or more images and obtain point-cloud-based queries based on the point cloud. The image-based three-dimensional features and the point-cloud-based three-dimensional features may be combined based on the image-based queries and the point-cloud-based queries using a self-attention transformer. For example, combiner 244 may be, or may include a self-attention transformer.

Combiner 244 may receive image-based queries 216 and/or point-cloud-based queries 236 and may combine image-based features 222 and point-cloud-based features 232 based on image-based queries 216 and/or point-cloud-based queries 236. In some aspects, the computing device (or one or more components thereof) may generate the image-based queries based on a subset of the image features. For example, combiner 214 may generate image-based queries 216 based on subset of image features 220.

In some aspects, the computing device (or one or more components thereof) may obtain map-based three-dimensional features derived from a point map of the environment.

The map-based three-dimensional features may also be combined into the combined three-dimensional features. For example, combiner 108 may obtain map-based features 106 and may combine map-based features 106 with image-based features 102 and point-cloud-based features 104 to generate combined features 110. As another example, combiner 244 may obtain map-based features 242 and combine map-based features 242 with image-based features 222 and point-cloud-based features 232 when generating combined features 246.

In some aspects, the computing device (or one or more components thereof) may obtain a point map and generate the map-based three-dimensional features based on the point map. For example, map encoder 240 may obtain point map 238 and generate map-based features 242 based on point map 238. In some aspects, the map-based three-dimensional features may be generated using a machine-learning encoder. For example, map encoder 240 may be, or may include, a machine-learning encoder. In some aspects, the point map may be, or may include, a high-definition (HD) map. For example, point map 238 may be, or may include, an HD map.

### Xxx

At block 314, the computing device (or one or more components thereof) may generate a road profile based on the combined three-dimensional features. For example, road-profile generator 112 of FIG. 1 may generate road profile 114 of FIG. 1 based on combined features 110. As another example, decoder 248 of FIG. 2 may generate road profile 250 of FIG. 2 based on combined features 246.

In some aspects, the road profile may be, or may include, coefficients of a polynomial representation of a surface of the road. In some aspects, the computing device (or one or more components thereof) may to generate an uncertainty map related to the subset of the image features. The road profile may be based at least in part on the uncertainty map. For example, decoder 208 may generate uncertainty maps 212 and decoder 248 may generate road profile 250 at least partially based on uncertainty maps 212.

In some aspects, the computing device (or one or more components thereof) may generate a perturbation map based on the combined three-dimensional features. For example, road-profile generator 112 may generate perturbation map 116 of FIG. 1. As another example, decoder 248 may generate perturbation map 252 of FIG. 2. In some aspects, the perturbation map may be, or may include, a representation of deviations from the road profile.

In some aspects, the computing device (or one or more components thereof) may perform one or more of: determining a location of a vehicle relative to the road based on the road profile; transmitting the road profile to a server, wherein the server is configured to generate or update a point map of the road; planning a path of a vehicle based on the road profile; or detecting objects in the environment based on the road profile. In some aspects, process 300 may be performed by an autonomous or semi-autonomous vehicle driving on the road.

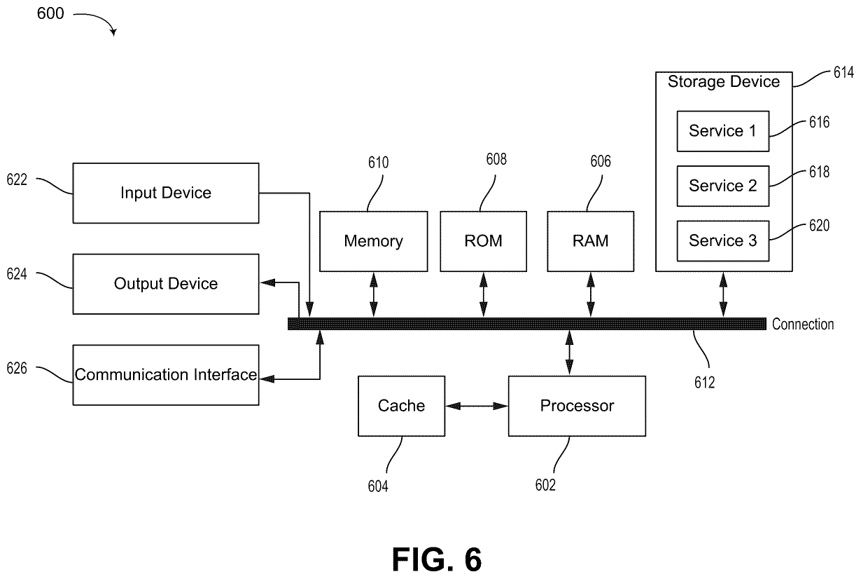

In some examples, as noted previously, the methods described herein (e.g., process 300 of FIG. 3, and/or other methods described herein) can be performed, in whole or in part, by a computing device or apparatus. In one example, one or more of the methods (e.g., process 300 of FIG. 3, and/or other methods described herein) can be performed, in whole or in part, by the computing-device architecture 600 shown in FIG. 6. For instance, a computing device with the computing-device architecture 600 shown in FIG. 6 can implement the operations of process 300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 300 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

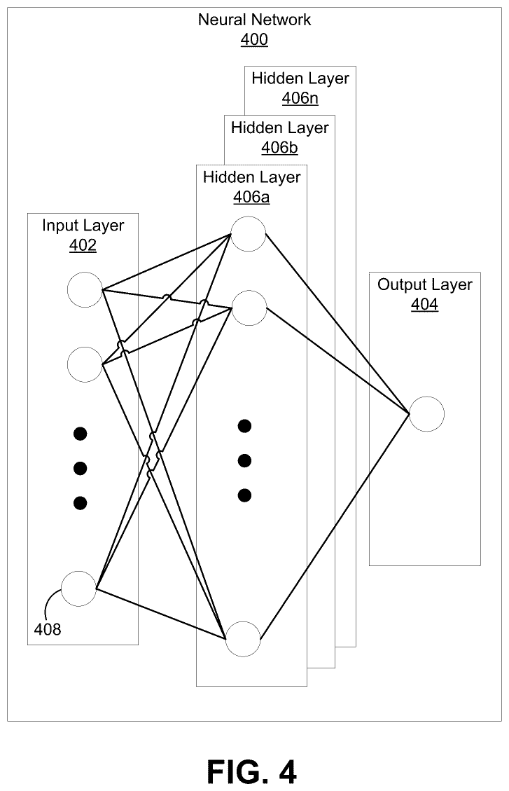

FIG. 4 is an illustrative example of a neural network 400 (e.g., a deep-learning neural network) that can be used to implement the machine-learning based image feature extraction, point-cloud feature extraction, point-map feature extraction, feature segmentation, feature combination, encoding, decoding, implicit-neural-representation generation, rendering, and/or classification described above. Neural network 400 may be an example of, or can implement any of, combiner 108 of FIG. 1, road-profile generator 112 of FIG. 1, image encoder 204 of FIG. 2, decoder 208 of FIG. 2, combiner 214 of FIG. 2, point-cloud encoder 226 of FIG. 2, map encoder 240 of FIG. 2, combiner 244 of FIG. 2, and/or decoder 248 of FIG. 2.

An input layer 402 includes input data. For example, input layer 402 can include data representing any of images 202 of FIG. 2, point clouds 224 of FIG. 2, or point map 238 of FIG. 2. Neural network 400 includes multiple hidden layers hidden layers 406a, 406b, through 406n. The hidden layers 406a, 406b, through hidden layer 406n include “n” number of hidden layers, where “n” is an integer greater than or equal to one. The number of hidden layers can be made to include as many layers as needed for the given application. Neural network 400 further includes an output layer 404 that provides an output resulting from the processing performed by the hidden layers 406a, 406b, through 406n. In one illustrative example, output layer 404 can provide any of image features 206 of FIG. 2, segmentation maps 210 of FIG. 2, uncertainty maps 212 of FIG. 2, image-based features 222 of FIG. 2, sparse features 228 of FIG. 2, map-based features 242 of FIG. 2, and/or combined features 246 of FIG. 2.

Neural network 400 can be, or can include, a multi-layer neural network of interconnected nodes. Each node can represent a piece of information. Information associated with the nodes is shared among the different layers and each layer retains information as information is processed. In some cases, neural network 400 can include a feed-forward network, in which case there are no feedback connections where outputs of the network are fed back into itself. In some cases, neural network 400 can include a recurrent neural network, which can have loops that allow information to be carried across nodes while reading in input.

Information can be exchanged between nodes through node-to-node interconnections between the various layers. Nodes of input layer 402 can activate a set of nodes in the first hidden layer 406a. For example, as shown, each of the input nodes of input layer 402 is connected to each of the nodes of the first hidden layer 406a. The nodes of first hidden layer 406a can transform the information of each input node by applying activation functions to the input node information. The information derived from the transformation can then be passed to and can activate the nodes of the next hidden layer 406b, which can perform their own designated functions. Example functions include convolutional, up-sampling, data transformation, and/or any other suitable functions. The output of the hidden layer 406b can then activate nodes of the next hidden layer, and so on. The output of the last hidden layer 406n can activate one or more nodes of the output layer 404, at which an output is provided. In some cases, while nodes (e.g., node 408) in neural network 400 are shown as having multiple output lines, a node has a single output and all lines shown as being output from a node represent the same output value.

In some cases, each node or interconnection between nodes can have a weight that is a set of parameters derived from the training of neural network 400. Once neural network 400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 400 to be adaptive to inputs and able to learn as more and more data is processed.

Neural network 400 may be pre-trained to process the features from the data in the input layer 402 using the different hidden layers 406a, 406b, through 406n in order to provide the output through the output layer 404. In an example in which neural network 400 is used to identify features in images, neural network 400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 400 is trained well enough so that the weights of the layers are accurately tuned.

For the example of identifying objects in images, the forward pass can include passing a training image through neural network 400. The weights are initially randomized before neural network 400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = Σ \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dl .}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 400 can include any other deep network other than a CNN, such as an autoencoder, a deep belief nets (DBNs), a Recurrent Neural Networks (RNNs), among others.

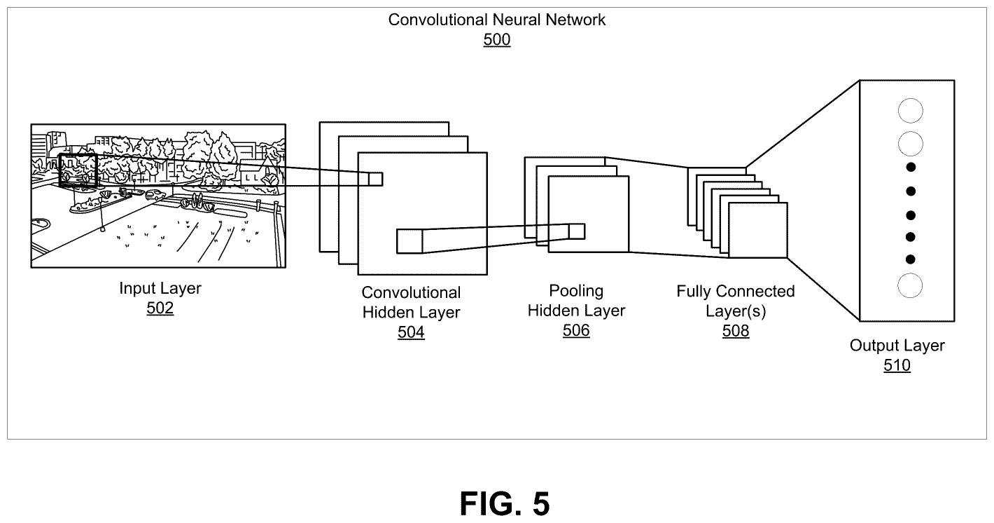

FIG. 5 is an illustrative example of a convolutional neural network (CNN) 500. The input layer 502 of the CNN 500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 504, an optional non-linear activation layer, a pooling hidden layer 506, and fully connected layer 508 (which fully connected layer 508 can be hidden) to get an output at the output layer 510. While only one of each hidden layer is shown in FIG. 5, one of ordinary skill will appreciate that multiple convolutional hidden layers, non-linear layers, pooling hidden layers, and/or fully connected layers can be included in the CNN 500. As previously described, the output can indicate a single class of an object or can include a probability of classes that best describe the object in the image.

The first layer of the CNN 500 can be the convolutional hidden layer 504. The convolutional hidden layer 504 can analyze image data of the input layer 502. Each node of the convolutional hidden layer 504 is connected to a region of nodes (pixels) of the input image called a receptive field. The convolutional hidden layer 504 can be considered as one or more filters (each filter corresponding to a different activation or feature map), with each convolutional iteration of a filter being a node or neuron of the convolutional hidden layer 504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 504. Each connection between a node and a receptive field for that node learns a weight and, in some cases, an overall bias such that each node learns to analyze its particular local receptive field in the input image. Each node of the convolutional hidden layer 504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 504 is due to each node of the convolutional layer being applied to its corresponding receptive field. For example, a filter of the convolutional hidden layer 504 can begin in the top-left corner of the input image array and can convolve around the input image. As noted above, each convolutional iteration of the filter can be considered a node or neuron of the convolutional hidden layer 504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 504. For example, a filter can be moved by a step amount (referred to as a stride) to the next receptive field. The stride can be set to 1 or another suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 504.

The mapping from the input layer to the convolutional hidden layer 504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 504 can include several activation maps in order to identify multiple features in an image. The example shown in FIG. 5 includes three activation maps. Using three activation maps, the convolutional hidden layer 504 can detect three different kinds of features, with each feature being detectable across the entire image.

In some examples, a non-linear hidden layer can be applied after the convolutional hidden layer 504. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 500 without affecting the receptive fields of the convolutional hidden layer 504.

The pooling hidden layer 506 can be applied after the convolutional hidden layer 504 (and after the non-linear hidden layer when used). The pooling hidden layer 506 is used to simplify the information in the output from the convolutional hidden layer 504. For example, the pooling hidden layer 506 can take each activation map output from the convolutional hidden layer 504 and generates a condensed activation map (or feature map) using a pooling function. Max-pooling is one example of a function performed by a pooling hidden layer. Other forms of pooling functions be used by the pooling hidden layer 506, such as average pooling, L2-norm pooling, or other suitable pooling functions. A pooling function (e.g., a max-pooling filter, an L2-norm filter, or other suitable pooling filter) is applied to each activation map included in the convolutional hidden layer 504. In the example shown in FIG. 5, three pooling filters are used for the three activation maps in the convolutional hidden layer 504.

In some examples, max-pooling can be used by applying a max-pooling filter (e.g., having a size of 2×2) with a stride (e.g., equal to a dimension of the filter, such as a stride of 2) to an activation map output from the convolutional hidden layer 504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 504 having a dimension of 24×24 nodes, the output from the pooling hidden layer 506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 500.

The final layer of connections in the network is a fully-connected layer that connects every node from the pooling hidden layer 506 to every one of the output nodes in the output layer 510. Using the example above, the input layer includes 28×28 nodes encoding the pixel intensities of the input image, the convolutional hidden layer 504 includes 3×24×24 hidden feature nodes based on application of a 5×5 local receptive field (for the filters) to three activation maps, and the pooling hidden layer 506 includes a layer of 3×12×12 hidden feature nodes based on application of max-pooling filter to 2×2 regions across each of the three feature maps. Extending this example, the output layer 510 can include ten output nodes. In such an example, every node of the 3×12×12 pooling hidden layer 506 is connected to every node of the output layer 510.

The fully connected layer 508 can obtain the output of the previous pooling hidden layer 506 (which should represent the activation maps of high-level features) and determines the features that most correlate to a particular class. For example, the fully connected layer 508 can determine the high-level features that most strongly correlate to a particular class and can include weights (nodes) for the high-level features. A product can be computed between the weights of the fully connected layer 508 and the pooling hidden layer 506 to obtain probabilities for the different classes. For example, if the CNN 500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 510 can include an M-dimensional vector (in the prior example, M=10). M indicates the number of classes that the CNN 500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 6 illustrates an example computing-device architecture 600 of an example computing device which can implement the various techniques described herein. In some examples, the computing device can include a vehicle (or computing device of a vehicle), a mobile device, a wearable device, an extended reality device (e.g., a virtual reality (VR) device, an augmented reality (AR) device, or a mixed reality (MR) device), a personal computer, a laptop computer, a video server, or other device. For example, the computing-device architecture 600 may include, implement, or be included in any or all of system 100 of FIG. 1 or system 200 of FIG. 2.

The components of computing-device architecture 600 are shown in electrical communication with each other using connection 612, such as a bus. The example computing-device architecture 600 includes a processing unit (CPU or processor) 602 and computing device connection 612 that couples various computing device components including computing device memory 610, such as read only memory (ROM) 608 and random-access memory (RAM) 606, to processor 602.

Computing-device architecture 600 can include a cache of high-speed memory connected directly with, in close proximity to, or integrated as part of processor 602. Computing-device architecture 600 can copy data from memory 610 and/or the storage device 614 to cache 604 for quick access by processor 602. In this way, the cache can provide a performance boost that avoids processor 602 delays while waiting for data. These and other modules can control or be configured to control processor 602 to perform various actions. Other computing device memory 610 may be available for use as well. Memory 610 can include multiple different types of memory with different performance characteristics. Processor 602 can include any general-purpose processor and a hardware or software service, such as service 1 616, service 2 618, and service 3 620 stored in storage device 614, configured to control processor 602 as well as a special-purpose processor where software instructions are incorporated into the processor design. Processor 602 may be a self-contained system, containing multiple cores or processors, a bus, memory controller, cache, etc. A multi-core processor may be symmetric or asymmetric.

To enable user interaction with the computing-device architecture 600, input device 622 can represent any number of input mechanisms, such as a microphone for speech, a touch-sensitive screen for gesture or graphical input, keyboard, mouse, motion input, speech and so forth. Output device 624 can also be one or more of a number of output mechanisms known to those of skill in the art, such as a display, projector, television, speaker device, etc. In some instances, multimodal computing devices can enable a user to provide multiple types of input to communicate with computing-device architecture 600. Communication interface 626 can generally govern and manage the user input and computing device output. There is no restriction on operating on any particular hardware arrangement and therefore the basic features here may easily be substituted for improved hardware or firmware arrangements as they are developed.

Storage device 614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 606, read only memory (ROM) 608, and hybrids thereof. Storage device 614 can include services 616, 618, and 620 for controlling processor 602. Other hardware or software modules are contemplated. Storage device 614 can be connected to the computing device connection 612. In one aspect, a hardware module that performs a particular function can include the software component stored in a computer-readable medium in connection with the necessary hardware components, such as processor 602, connection 612, output device 624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for determining road profiles, the apparatus comprising: at least one memory; and at least one processor coupled to the at least one memory and configured to: extract image features from one or more images of an environment, wherein the environment includes a road; generate a segmentation mask based on the image features; determine a subset of the image features based on the segmentation mask; generate image-based three-dimensional features based on the subset of the image features; obtain point-cloud-based three-dimensional features derived from a point cloud representative of the environment; combine the image-based three-dimensional features and the point-cloud-based three-dimensional features to generate combined three-dimensional features; and generate a road profile based on the combined three-dimensional features.

Aspect 2. The apparatus of aspect 1, wherein the determined subset of image features comprise features related to at least one of the road or lane boundaries of the road.

Aspect 3. The apparatus of any one of aspects 1 or 2, wherein the at least one processor is further configured to generate image-based queries based on the subset of the image features.

Aspect 4. The apparatus of any one of aspects 1 to 3, wherein the at least one processor is further configured to generate an uncertainty map related to the subset of the image features, wherein the road profile is based at least in part on the uncertainty map.

Aspect 5. The apparatus of any one of aspects 1 to 4, wherein, to generate the image-based three-dimensional features, the at least one processor is further configured to unproject the subset of the image features.

Aspect 6. The apparatus of any one of aspects 1 to 5, wherein the at least one processor is further configured to: obtain image-based queries based on the one or more images; and obtain point-cloud-based queries based on the point cloud; wherein the image-based three-dimensional features and the point-cloud-based three-dimensional features are combined based on the image-based queries and the point-cloud-based queries using a self-attention transformer.

Aspect 7. The apparatus of any one of aspects 1 to 6, wherein the at least one processor is further configured to obtain map-based three-dimensional features derived from a point map of the environment, wherein the map-based three-dimensional features are also combined into the combined three-dimensional features.

Aspect 8. The apparatus of aspect 7, wherein the at least one processor is further configured to: obtain a point map; and generate the map-based three-dimensional features based on the point map.

Aspect 9. The apparatus of aspect 8, wherein the point map comprises a high-definition (HD) map.

Aspect 10. The apparatus of any one of aspects 1 to 9, wherein the at least one processor is further configured to generate a perturbation map based on the combined three-dimensional features.

Aspect 11. The apparatus of aspect 10, wherein the perturbation map comprises a representation of deviations from the road profile.

Aspect 12. The apparatus of any one of aspects 1 to 11, wherein the road profile comprises coefficients of a polynomial representation of a surface of the road.

Aspect 13. The apparatus of any one of aspects 1 to 13, wherein the at least one processor is further configured to: obtain the point cloud; and generate the point-cloud-based three-dimensional features based on the point cloud.

Aspect 14. The apparatus of aspect 13, wherein the point cloud comprises alight detection and ranging (LIDAR) point cloud.

Aspect 15. The apparatus of any one of aspects 1 to 14, wherein the at least one processor is further configured to perform an operation, wherein the operation is: determining a location of a vehicle relative to the road based on the road profile; transmitting the road profile to a server, wherein the server is configured to generate or update a point map of the road; planning a path of a vehicle based on the road profile; or detecting objects in the environment based on the road profile.

Aspect 16. The apparatus of any one of aspects 1 to 15, wherein the apparatus is included in an autonomous or semi-autonomous vehicle driving on the road.

Aspect 17. A method for determining road profiles, the method comprising: extracting image features from one or more images of an environment, wherein the environment includes a road; generating a segmentation mask based on the image features; determining a subset of the image features based on the segmentation mask; generating image-based three-dimensional features based on the subset of the image features; obtaining point-cloud-based three-dimensional features derived from a point cloud representative of the environment; combining the image-based three-dimensional features and the point-cloud-based three-dimensional features to generate combined three-dimensional features; and generating a road profile based on the combined three-dimensional features.

Aspect 18. The method of aspect 17, wherein the determined subset of image features comprise features related to at least one of the road or lane boundaries of the road.

Aspect 19. The method of any one of aspects 17 or 18, further comprising generating image-based queries based on the subset of the image features.

Aspect 20. The method of any one of aspects 17 to 19, further comprising generating an uncertainty map related to the subset of the image features, wherein the road profile is based at least in part on the uncertainty map.

Aspect 21. The method of any one of aspects 17 to 20, wherein generating the image-based three-dimensional features comprises unprojecting the subset of the image features.

Aspect 22. The method of any one of aspects 17 to 21, further comprising: obtaining image-based queries based on the one or more images; and obtaining point-cloud-based queries based on the point cloud; wherein the image-based three-dimensional features and the point-cloud-based three-dimensional features are combined based on the image-based queries and the point-cloud-based queries using a self-attention transformer.

Aspect 23. The method of any one of aspects 17 to 22, further comprising obtaining map-based three-dimensional features derived from a point map of the environment, wherein the map-based three-dimensional features are also combined into the combined three-dimensional features.

Aspect 24. The method of aspect 23, further comprising: obtaining a point map; and generating the map-based three-dimensional features based on the point map.

Aspect 25. The method of aspect 24, wherein the point map comprises a high-definition (HD) map.

Aspect 26. The method of any one of aspects 17 to 25, further comprising generating a perturbation map based on the combined three-dimensional features.

Aspect 27. The method of aspect 26, wherein the perturbation map comprises a representation of deviations from the road profile.

Aspect 28. The method of any one of aspects 17 to 27, wherein the road profile comprises coefficients of a polynomial representation of a surface of the road.

Aspect 29. The method of any one of aspects 17 to 28, further comprising: obtaining the point cloud; and generating the point-cloud-based three-dimensional features based on the point cloud.

Aspect 30. The method of aspect 29, wherein the point cloud comprises a light detection and ranging (LIDAR) point cloud.

Aspect 31. The method of any one of aspects 17 to 30, further comprising an operation, wherein the operation is: determining a location of a vehicle relative to the road based on the road profile; transmitting the road profile to a server, wherein the server is configured to generate or update a point map of the road; planning a path of a vehicle based on the road profile; or detecting objects in the environment based on the road profile.

Aspect 32. The method of any one of aspects 17 to 31, wherein the method is performed by an autonomous or semi-autonomous vehicle driving on the road.

Aspect 33. The method of any one of aspects 17 to 32, wherein the road profile is generated using a machine learning-based decoder.

Aspect 34. The method of aspect 23, wherein map-based three-dimensional features are generated using a machine-learning encoder.

Aspect 35. The method of any one of aspects 17 to 34, wherein the image features are extracted using a machine-learning encoder.

Aspect 36. The method of any one of aspects 17 to 35, wherein the segmentation mask is generated using a semantic segmentation machine-learning network or an instance segmentation machine-learning network.

Aspect 37. The method of aspect 22, wherein point-cloud-based three-dimensional features are generated using a machine-learning encoder.

Aspect 38. A non-transitory computer-readable storage medium having stored thereon instructions that, when executed by at least one processor, cause the at least one processor to perform operations according to any of aspects 17 to 37

Aspect 39. An apparatus for providing virtual content for display, the apparatus comprising one or more means for perform operations according to any of aspects 17 to 37.

What is claimed is:

1. An apparatus for determining road profiles, the apparatus comprising:
at least one memory; and
at least one processor coupled to the at least one memory and configured to:
extract image features from one or more images of an environment, wherein the environment includes a road;
generate a segmentation mask based on the image features;
determine a subset of the image features based on the segmentation mask;
generate image-based three-dimensional features based on the subset of the image features;
obtain point-cloud-based three-dimensional features derived from a point cloud representative of the environment;
combine the image-based three-dimensional features and the point-cloud-based three-dimensional features to generate combined three-dimensional features; and
generate a road profile based on the combined three-dimensional features.

2. The apparatus of claim 1, wherein the determined subset of image features comprise features related to at least one of the road or lane boundaries of the road.

3. The apparatus of claim 1, wherein the at least one processor is further configured to generate image-based queries based on the subset of the image features.

4. The apparatus of claim 1, wherein the at least one processor is further configured to generate an uncertainty map related to the subset of the image features, wherein the road profile is based at least in part on the uncertainty map.

5. The apparatus of claim 1, wherein, to generate the image-based three-dimensional features, the at least one processor is further configured to unproject the subset of the image features.

6. The apparatus of claim 1, wherein the at least one processor is further configured to:
obtain image-based queries based on the one or more images; and
obtain point-cloud-based queries based on the point cloud;
wherein the image-based three-dimensional features and the point-cloud-based three-dimensional features are combined based on the image-based queries and the point-cloud-based queries using a self-attention transformer.

7. The apparatus of claim 1, wherein the at least one processor is further configured to obtain map-based three-dimensional features derived from a point map of the environment, wherein the map-based three-dimensional features are also combined into the combined three-dimensional features.

8. The apparatus of claim 7, wherein the at least one processor is further configured to:
obtain a point map; and
generate the map-based three-dimensional features based on the point map.

9. The apparatus of claim 8, wherein the point map comprises a high-definition (HD) map.

10. The apparatus of claim 1, wherein the at least one processor is further configured to generate a perturbation map based on the combined three-dimensional features.

11. The apparatus of claim 10, wherein the perturbation map comprises a representation of deviations from the road profile.

12. The apparatus of claim 1, wherein the road profile comprises coefficients of a polynomial representation of a surface of the road.

13. The apparatus of claim 1, wherein the at least one processor is further configured to:
obtain the point cloud; and
generate the point-cloud-based three-dimensional features based on the point cloud.

14. The apparatus of claim 13, wherein the point cloud comprises a light detection and ranging (LIDAR) point cloud.

15. The apparatus of claim 1, wherein the at least one processor is further configured to perform an operation, wherein the operation is:
determining a location of a vehicle relative to the road based on the road profile;
transmitting the road profile to a server, wherein the server is configured to generate or update a point map of the road;
planning a path of a vehicle based on the road profile; or
detecting objects in the environment based on the road profile.

16. The apparatus of claim 1, wherein the apparatus is included in an autonomous or semi-autonomous vehicle.

17. A method for determining road profiles, the method comprising:
extracting image features from one or more images of an environment, wherein the environment includes a road;
generating a segmentation mask based on the image features;
determining a subset of the image features based on the segmentation mask;
generating image-based three-dimensional features based on the subset of the image features;
obtaining point-cloud-based three-dimensional features derived from a point cloud representative of the environment;
combining the image-based three-dimensional features and the point-cloud-based three-dimensional features to generate combined three-dimensional features; and
generating a road profile based on the combined three-dimensional features.

18. The method of claim 17, wherein the determined subset of image features comprise features related to at least one of the road or lane boundaries of the road.

19. The method of claim 17, further comprising generating image-based queries based on the subset of the image features.

20. The method of claim 17, further comprising generating an uncertainty map related to the subset of the image features, wherein the road profile is based at least in part on the uncertainty map.

21. The method of claim 17, wherein generating the image-based three-dimensional features comprises unprojecting the subset of the image features.

22. The method of claim 17, further comprising:
obtaining image-based queries based on the one or more images; and
obtaining point-cloud-based queries based on the point cloud;
wherein the image-based three-dimensional features and the point-cloud-based three-dimensional features are combined based on the image-based queries and the point-cloud-based queries using a self-attention transformer.

23. The method of claim 17, further comprising obtaining map-based three-dimensional features derived from a point map of the environment, wherein the map-based three-dimensional features are also combined into the combined three-dimensional features.

24. The method of claim 23, further comprising:
obtaining a point map; and
generating the map-based three-dimensional features based on the point map.

25. The method of claim 24, wherein the point map comprises a high-definition (HD) map.

26. The method of claim 17, further comprising generating a perturbation map based on the combined three-dimensional features.

27. The method of claim 26, wherein the perturbation map comprises a representation of deviations from the road profile.

28. The method of claim 17, wherein the road profile comprises coefficients of a polynomial representation of a surface of the road.

29. The method of claim 17, further comprising:
obtaining the point cloud; and
generating the point-cloud-based three-dimensional features based on the point cloud.

30. The method of claim 17, further comprising an operation, wherein the operation is at least one of:
determining a location of a vehicle relative to the road based on the road profile;
transmitting the road profile to a server, wherein the server is configured to generate or update a point map of the road;
planning a path of a vehicle based on the road profile; or
detecting objects in the environment based on the road profile.
